(19) United States
(12) Patent Application Publication
(10) Pub. No.: US 2023/0149862 A1
(43) Pub. Date: May 18, 2023

(54) All Ceramic High Efficiency Diffuser with Ceramic Membrane

(71) Applicant: Chad Sheckler

(72) Inventor: Chad Sheckler

(73) Assignee: Seneca Ceramics, Inc., Phelps, NY (US)

(21) Appl. No.: 17/528,261

(22) Filed: Nov. 17, 2021

(51) Int. Cl. B01F 3/04

(52) U.S. Cl. CPC B01F 3/04262; B01F 2003/0439; B01F 2003/04879; B01F 2215/0052; B01F 2215/0431

(57) ABSTRACT

An all-ceramic diffuser supplies microbubbles of a narrow range of size to create a steady flow of bubbles of generally uniform size in an aqueous medium, such as process water in a wastewater treatment plant. The diffuser is formed of a porous body core, with pore sizes of e.g. 30 µm or larger, an upper ceramic membrane that covers the upper surface of the body core, and has mean pore size of e.g., 3 to 15 µm. A lower ceramic membrane covers the bottom surface of the body core, and has a finer pore size than the upper ceramic membrane, so that the capillary pore size of the smaller pores will act as a seal; consequently all of the air flow is through the upper ceramic membrane. A ceramic fitting connects the associated air supply with the porous body core which serves as plenum.

A new category of diffuser or sparger, namely an All Ceramic Diffuser has been successfully constructed and tested, and is based on hydrophillic ceramic membrane technology. The ceramic membrane provides fine, highly uniform bubbles based on control of pore size distribution, surface chemistry, composition and composite structure of the diffuser or sparger. The configuration of the all-ceramic diffuser, plus control over membrane pore size and size distribution results in the diffuser providing a steady stream of highly uniform microbubbles. The construction gives the diffuser a very high “gas transfer” efficiency, high energy efficiency, easy to maintain or even maintenance-free operation, easily maintained seals, and extremely good oxidation resistance.

Diffusion or sparging of gas bubbles into liquids is used in many different processes. These can include physical air flotation, wastewater treatment, molten metal processing, ozonation, chemical reactors, and bio-reactors. The performance efficiency in such systems is almost entirely dependent on the bubble size and the bubble size distribution in the gas bubbles or microbubbles that emerge from the diffuser. The amount of bubble surface area per unit mass of the gas is higher for smaller bubbles. Efficiency of transfer is greater when the bubbles all rise at the same and constant rate, which occurs when the bubbles are all nearly the same size. Many mechanisms have been used to introduce the bubbles into the liquid. These include impellers, spargers (or diffusers), and inductors. Each gas introduction system has limitations associated with diffused gas production, volume, and gas transfer efficiency. We have found that an all-ceramic diffuser, with a microporous ceramic skin or membrane produces a very even flow of the gas into the liquid at a wide range of static head pressure conditions.

The application that we have selected to demonstrate the technology’s value is waste water treatment. In that particular field. the single largest cost in wastewater treatment is the energy required to compress air to feed through the diffusers into the sludge. Present day diffuser grids that the wastewater treatment plant uses to introduce the air into the sludge are limited in terms of oxygen transfer efficiency. Current diffusion can dissolve only between 10% and 20% of the available oxygen contained in the air into the waste water when operating in a 4 meter to 5 meter deep tank. The current diffuser designs create bubbles over a fairly large size range so the bubbles rise in the aqueous sludge or wastewater. The larger bubbles rise faster than the smaller ones, and the bubbles tend to merge into large bubbles, rather than remain as the desired microbubbles.

The ceramic membrane diffuser proposed in our invention addresses the need for greater oxygen take-up and more efficient creation of microbubbles, as well as the desired reduction in the pressure and in the energy needed to compress the air to feed the diffuser. The proposed all-ceramic diffuser will increase both the oxygen transfer efficiency and the operating energy efficiency by a factor of greater than double over all commercially available fine bubble diffusers. At the same time the ceramic membrane diffuser design that we are proposing will minimize the problems with sealing issues associated with leaks and hydrophobic oils that leach into the porous ceramics from elastomeric seals. The all-ceramic diffusers according to our invention have these advantageous features:
A robust all ceramic-and-glass diffuser body;
A porous ceramic core that is 30-50% porous with a low resistance to air flow, and with a recess or socket formed in the ceramic material to bond a ceramic gas-fitting orifice using a leakproof glass or glass-ceramic bond.
A sparging surface covering the upper half of the ceramic core or body is composed of a ceramic membrane that has a capillary pore size that is smaller than the capillary pore size of the core and is integrally bonded to the ceramic core.
A ceramic membrane or shell of finer pore size, or a nonporous ceramic membrane is positioned on the bottom surface of the core, and is integrally bonded to the core to act as a seal.
A ceramic connector or fitting links the diffuser to the gas source. The fitting is integrally connected to the core and membrane by a permanent, leakproof ceramic or glass bonding system.

The ceramic membrane has a hydrophilic nature that allows the core to behave as a plenum, and provides even pressure across the inside surface of the upper ceramic membrane.

In accordance with an aspect of the present invention, an all-ceramic diffuser is designed and configured to create an upward air stream of uniform microbubbles of a gas within a volume of liquid, with the microbubbles being of a substantially uniform size and within a narrow size distribution to achieve a high transfer efficiency of the gas into the liquid.

A body core is composed of all ceramic-glass construction having a porosity of at least substantially 30%, and having an upper surface portion, a lower surface portion, and a socket formed therein to receive a toughened ceramic gas fitting.

A ceramic gas fitting adapted to mate with the body core at the socket is bonded to the socket along the outer rim of the fitting. The fitting is preferably a toughened ceramic that is bonded to the core using a glass or glass/ceramic bonding system. Favorably, this fitting is formed with a nipple to connect with a gas supply.

A sparging ceramic membrane covers the upper surface portion of the body core and has a multiplicity of capillary pores formed in it/ Favorably, this ceramic membrane has capillary pore size with a mean diameter within a range of between 3 µm and 15 µm and a size distribution of substantially ± 10%, or less. Finally, a bottom membrane covers at least the lower surface of the body core, and all the capillary pores thereof are smaller than the capillary pores of the sparging ceramic membrane. The body core can favorably be elongated horizontally and shortened vertically.

The body core can have a generally rounded oblate shape with generally flattened upper and lower surfaces and a rounded circumferential surface and maybe in the shape of a flat thick disk with a rounded outer edge. In these embodiments, the socket is favorably formed as a recess positioned at a center of the lower surface portion.

In an embodiment described herein, the pore size characteristic A of the body core, the pore size characteristic C of the sparging ceramic membrane, and the pore size characteristic D of the bottom membrane are progressively finer size order, that is A > C > D. The bottom membrane may have a pore size down to zero, or a size slightly smaller than the upper sparging ceramic membrane pore size, so that the upper surface pores provide the path of least resistance and all microbubbles form there.

The ceramic material, for all membranes, should be hydrophilic, and may cover the entire upper body surface of the ceramic body core. These features cover the entire body portion so that the body core itself is not exposed directly to the liquid. Preferably, the sparging ceramic membrane is integrally bonded to the ceramic diffuser core body, and the diffuser core body and the associated sparging ceramic membrane are configured to generate microbubbles when supplied with gas at a pressure of about 5 PSIG or a few PSI above or below. Any designated membranes should have a Dynamic Wet Pressure between 2 and 10 PSIG. (Dynamic wet pressure is the amount of gas pressure needed to overcome the capillary pressure of the liquid in the pores with the porous surface being only slightly immersed in the liquid.) The pressure values given in this description are based on testing in water. When doing actual Dynamic Wet Pressure testing, the liquid column above the porous ceramic diffuser is subtracted out to give the Dynamic Wet Pressure.

### BRIEF DESCRIPTION OF THE DRAWING

FIG. 1 is a schematic cross section of the Diffuser according to a preferred embodiment of the invention.

FIG. 2 is aa graph comparing the effectiveness of an oxygen gas diffuser of the present invention compared with a diffuser of a standard (prior art) design.

FIG. 3A and FIG. 3B are data tables showing the performance of a diffuser of the prior art (FIG. 3A) with that of a diffuser of the present invention (FIG. 3B).

FIG. 4 illustrates an even distribution of uniform microbubbles as produced with the diffuser according to the present invention.

### DETAILED DESCRIPTION OF THE PREFERRED EMBODIMENT

As shown in the Drawing, and initially FIG. 1, an all-ceramic sparger or diffuser 10 comprises a ceramic body core 12 (Component A) that has a relatively high porosity, and with upper and lower microporous ceramic membranes 16 and 18, (Components C and D). A ceramic fitting 14 for connecting to a source of air, oxygen or other gas, fits into a recess 20 preferably centered in the bottom of the diffuser (FIG. 1- Component B). This also mounts and positions the diffuser onto the grid. A wastewater treatment plant can have up to several million diffusers in it. The connection on Component B can either be a barbed fitting, a threaded fitting, or an o-ring seal configuration. The core 12 is provided with different porous ceramic membranes coating it or covering it, namely the upper microporous ceramic membrane 16 and the lower ceramic membrane 18. The fitting 14 is shown here with a male nipple fitting into a vertical tubular supply pipe 22 from the gas grid of the waste water treatment plant. There are typically several dozens of these pipes 22 and likewise a similar number of these diffusers 10. The membranes are the same composition and crystalline structure as the core 12, or at least have the same thermal expansion coefficient as the core, so that the membranes do not spall off during the firing process.

The diffuser 10 is of ceramic and glass construction with the porous ceramic core 12 being 30-50% porous, and with a recess 20 formed on the center of its bottom or lower surface to serve as socket into which the fitting 14 or ceramic orifice is affixed, using a glass or ceramic bonding agent. The sparging surface which expands along the entire upper side of the ceramic core 12 is composed of the ceramic membrane 16 that has a capillary pore size that is smaller than the capillary pore size of the core and is integrally bonded to the ceramic core. The finer pore sized (or nonporous) ceramic membrane 18 on the bottom surface of the core is integrally bonded to the core to serve as a seal. No part of the body core 12 is in direct contact with the water or other fluid in which the diffuser is immersed. The fitting 14 serves as a ceramic connector that links the diffuser to the air plenum which is integrally connected via a matrix of piping or air tubing 22 to the core and membrane. A ceramic or glass bonding system affixes a nipple on the fitting 14 to an end of the tubing 22

The hydrophilic nature of the ceramic membrane allows the core to behave as a plenum. The sparger or diffuser is thus a composite of a porous ceramic core (12 - Component A) with a ceramic fitting (14- Component B) along with upper and lower membranes ( 16 and 18 -Components C and D). The core has different porous ceramic membranes coating it. The fitting (14- Component B) connects the diffuser to the grid. The connection on the fitting for connecting to the grid can be a barbed fitting, a threaded fitting, or an o-ring seal configuration.

The material that forms the body core 12 can be formed as described in the inventor’s earlier pat. no. 5,215,686, which may be considered as incorporated by reference. The relevant description may be found at col. 5, lines 35 - 53 and col. 6, lines 35 - 65 of the ‘686 patent. Coating with a ceramic or ceramic aggregate material is discussed at col. 4, lines 23 to 55, and the particle sizes employed may be selected to limit the size of the apertures in each respective ceramic membrane. Processes for forming the body core and the upper and lower microporous membranes can involve the procedures disclosed in the inventor’s prior pat. No. 5,560,874, particularly at col. 5, line 7 to Col 8, line 14. The ceramic membranes 16, 18 are preferably very thin, and optimum membrane thicknesses may be 100 µ to 300 µ.

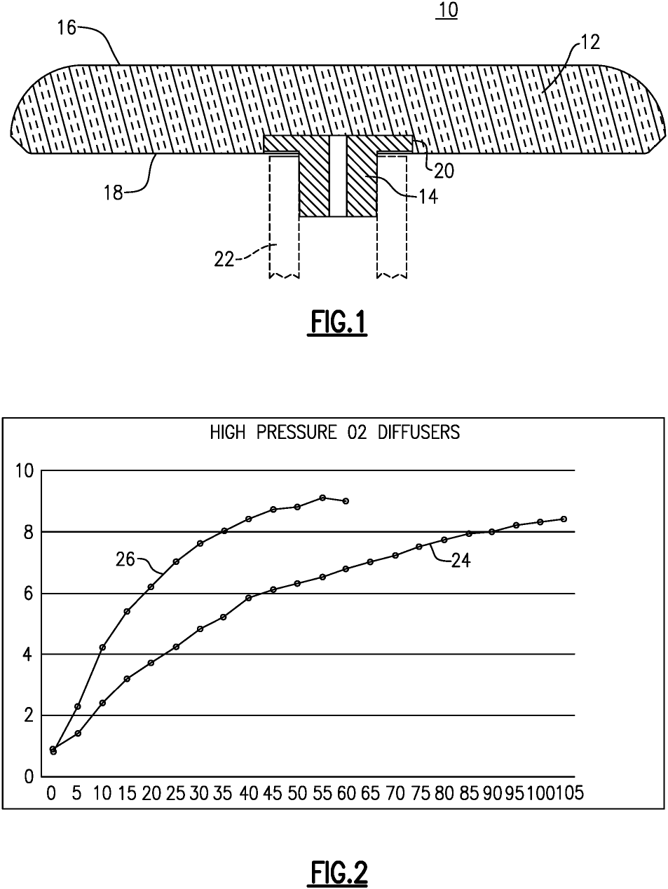

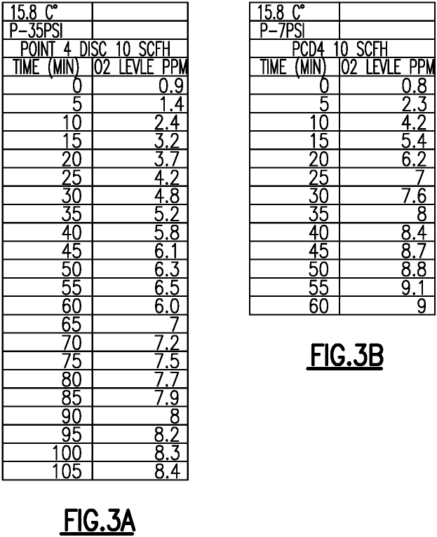

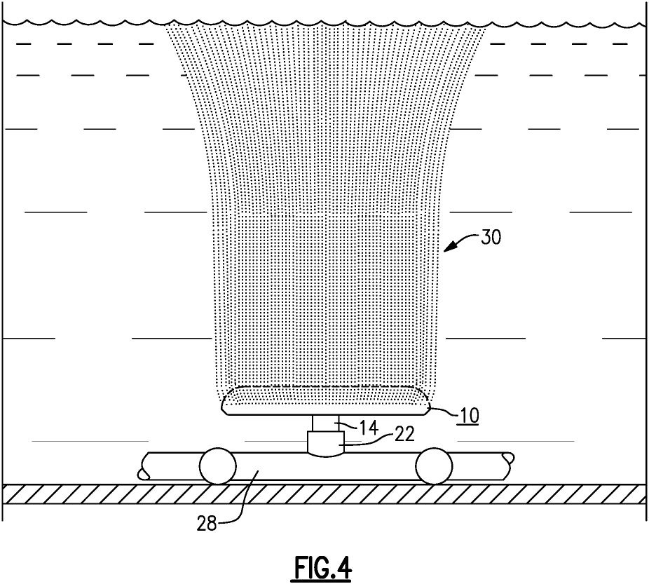

FIG. 2 shows the graphs of the uptake of oxygen in water from operation of the diffuser of this invention as compared with an available, commonly used diffuser of the prior art. The curve 24 represents the oxygen uptake in water from the diffuser of the present invention and curve 26 represents the performance of the available commonly used diffuser. The points of the graphs 24 and 26 are logged at the data tables of FIGS. 3A and 3B respectively. In both cases, air is bubbled into water which is at 15.8 Celsius with air supplied to the respective diffuser at 35 PSIG (FIG. 3A) and 7 PSIG (FIG. 3B), and the water is analyzed for oxygen every 300 seconds (5 minutes). In the case of the graph 24 and the table of FIG. 3a, the diffuser used was a Point 4 brand disk diffuser, and air was supplied at a flow rate of ten standard cubic feet per hour. The chart or curve 26 and FIG. 3B represent the performance of the all ceramic disc diffuser of this invention, i.e., with the flow rate of 10 SCFH. It can be seen that the oxygen is absorbed faster in the case of the diffuser of this invention, with the steeper O₂ absorption curve 26. That is with the prior art diffuser (curve 24, FIG. 3A data table) the diffuser requires 105 minutes to reach an absorbed oxygen level of 8.4 parts per million O₂, whereas the diffuser of this invention (curve 26, FIG. 3B) requires only 60 minutes to achieve a oxygen level of 9 ppm (parts per million), and only 40 minutes to achieve the oxygen level of 8.4 ppm that was only reached in 105 minutes on the prior art diffuser. And notably the diffuser of this invention required only 7 PSIG air pressure.

The porous gas diffusion layers, i.e., membranes 16 and 18 can be formed of zirconia (ZrSiO4) or alumina silicate (3Al₂O₃-2(SiO₂) as the material for the upper and lower ceramic membranes. The membranes are favorably made from Alpha Aluminum Oxide (Al₂O₃), and have the same thermal expansion coefficient as the core. The upper membrane 16, with its highly uniform array of micropores produces a steady and even slow-rising stream of microbubbles as seen in FIG. 4. The microbubbles all rise at a uniform rate and without colliding or bunching. This optimizes the rate of gas transfer into the liquid.

Typically, the ceramic material in the body core 12 has a capillary pore size with a mean in a range between 20 and 100 µm. The ceramic membrane 16 will have a capillary pore size with a mean in a range between 3 and 15 µm. and the ceramic membrane 18 has a capillary pore size distribution with a mean below that of the membrane 16, which can be between 0 and 2 µm. The membrane 16 on the upper surface of the diffuser will then be the active surface that releases bubbles or microbubbles into the liquid. The connecting fitting 14 is favorably made of a toughened ceramic such as partially stabilized zirconia or a zirconia toughened alumina material. This construction serves to prevent failure in high-stress structural areas, such as threads on the nipple portion of the fitting 14. An example of the diffusion head of this invention in action is shown in FIG. 4, which shows the diffuser 10 submerged in a depth of water or an aqueous fluid. The fitting 14 is connected to an air feed pipe 22 that is part of an air distribution network supplying air under sufficient pressure to a number of these diffusers 10, only one of which is shown.. The air bubbles of an acceptably uniform size, and, within a narrow range, form at the numerous small pores in the upper ceramic membrane, which is the path of least resistance for the air. This creates a stream 30 of microbubbles that proceed as a uniform upward flow that rises within the liquid, The small bubble size and the uniformity of them ensures that the oxygen in the bubbles is optimally transferred to the surrounding liquid, as demonstrated in FIG. 2.

In creating these diffusers, membrane pore size distribution control can be maintained using a very narrow particle size distribution of fused aluminum oxide, of the type that is used in the abrasives industry. These may typically be any grade between a 280 mesh and 1000 mesh. The membrane is less than 0.05 mm thick and is bonded with a very fine-grade clay/feldspar mixture (i.e., < 2 microns). The clay/feldspar bond can be anywhere from 2 to 20 weight% of the alumina used in the membrane.

While the diffuser of this invention has been described with reference to one preferred embodiment used for oxygenating water in a wastewater treatment facility, the invention is not to be limited only to that example or to a water treatment process. Rather many variations would become apparent to persons skilled in the art without departure from the principles of this invention, as defined in the appended claims.

What is claimed is:

1. All ceramic diffuser for creating an upward air stream of uniform microbubbles of a gas within a volume of a liquid, with the microbubbles being of a substantially uniform size and within a narrow size distribution to achieve a high transfer efficiency of the gas into the liquid; comprising:
a body core of all ceramic-glass construction having a porosity of at least substantially 30%, and having an upper surface portion, a lower surface portion, and a socket formed therein to receive a toughened ceramic gas fitting;
a toughened ceramic gas fitting adapted to mate with said body core at said socket and having a nipple to connect with a gas supply; the gas fitting being bonded to said socket using a ceramic-glass bonding system;
a sparging ceramic membrane covering an upper surface portion of said body core and having a multiplicity of capillary pores formed therein with a capillary pore size with a mean diameter within a range of between 3 µm and 15 µm and a size distribution of ±10%; and
a bottom membrane covering at least a lower surface of the body core with all capillary pores thereof being smaller than the capillary pores of said sparging ceramic membrane.

2. The all-ceramic diffuser according to claim 1 wherein said body core is elongated horizontally and shortened vertically.

3. The all-ceramic diffuser according to claim 1 wherein body core has a generally rounded oblate shape with generally flattened upper and lower surfaces and a rounded circumferential surface.

4. The all-ceramic diffuser according to claim 3 wherein said body core is in the shape of a flat thick disk with a rounded outer edge.

5. The all-ceramic diffuser according to claim 1 wherein the socket is as a recess formed at a center of said lower surface portion.

6. The all-ceramic diffuser according to claim 1 wherein the pore size characteristic A of the body core, the pore size characteristic C of the sparging ceramic membrane, and the pore size characteristic D of the bottom membrane are progressivly finer in the relation A > C > D.

7. The all-ceramic diffuser according to claim 1 wherein the sparging ceramic membrane, the bottom membrane, and the gas fitting together cover entire surface of the body core such that the core itself is not exposed directly to the liquid.

8. The all-ceramic diffuser according to claim 1 wherein the sparging ceramic membrane is integrally bonded to the ceramic diffuser core body.

9. The all-ceramic diffuser according to claim 1 wherein said diffuser core body and said sparging ceramic membrane are configured to generate said microbubbles when supplied with gas at a pressure in a range of about 2 to 10 PSIG .
